(19) United States
(12) Patent Application Publication
(10) Pub. No.: US 2020/0120311 A1
(43) Pub. Date: Apr. 16, 2020

(54) INTEGRATED MULTI-VIEW SURVEILLANCE CAMERA SYSTEM FOR VEHICLES

(71) Applicant: CHRIS PRITCHARD, Germantown, TN (US)

(72) Inventor: CHRIS PRITCHARD, Germantown, TN (US)

(21) Appl. No.: 16/509,434

(22) Filed: Jul. 11, 2019

Related U.S. Application Data
(63) Continuation of application No. 15/707,298, filed on Sep. 18, 2017, now abandoned.

(51) Int. Cl. H04N 7/18; G06K 9/00; G08G 1/16; G08B 13/196

(52) U.S. Cl. CPC H04N 7/183; G06K 9/00798; G08G 1/167; G06K 9/00805; B60W 2050/146; B60R 2300/105; B60R 2300/301; B60K 2370/777; G08B 13/19641

(57) ABSTRACT

An interior vehicle based imaging system that provides multiple real time and archival video images. The imaging system captures image data from a central multi-camera platform within the vehicle's rearview mirror. Image processes and process data storage via wireless communication links to internet cloud based archival storage and retrieval are provided. Optimal vehicle interior and exterior viewing angles are achieved to provide a complete visual documentation of the vehicle's environment including its occupant in a real time and accessible documentation record.

### BACKGROUND OF THE INVENTION

### 1. Technical Field

The present invention relates to image capturing devices, specifically video cameras that are used to monitor physical environments for documentation such as a vehicle.

### 2. Description of Prior Art

Prior art devices and systems of this type have been developed for use in moving vehicles, see for example U.S. Pat. Nos. 5,410,340, 6,333,759 and 8,090,153.

U.S. Pat. No. 5,410,340 illustrates a stereoscopic picture processing apparatus that captures a 3D view of objects or road shapes with their accurate positioning in relation to the vehicle.

U.S. Pat. No. 6,333,759 claims a 360-automobile video camera system having a multi-camera unit pivotally mounted on a bracket extending from the support arm of the rearview mirror.

U.S. Pat. No. 8,090,753 is directed to a front facing camera mounting recording system that captures the field of view in front of the vehicle.

### SUMMARY OF THE INVENTION

The present invention provides an integral multiple independent video camera array in a function vehicle rearview mirror configuration. Multiple directionally positioned video cameras are configured within a vehicle's rearview mirror on an integrated circuit board installation having independent video imaging processors and wireless communication enabled circuitry. The cameras provide interlinking exterior fields of view as well as document vehicles interior and its passengers, all in real time and transmitted to an internet based cloud server for retrieval and storage.

### DESCRIPTION OF THE DRAWINGS

FIG. 1 is a front elevational view of the imaging recording system in a vehicle's rearview mirror configuration.

FIG. 2 is a rear elevational view thereof.

FIG. 3 is a front elevational view of an integrated electronic circuit board and multiple camera mounting platform.

FIG. 4 is an exploded perspective view of the mirror imaging recording system for a vehicle.

FIG. 5 is a top plan view graphic representation of a vehicle with the image recording system of the invention illustrating multiple camera fields of view.

FIG. 6 is a block flow diagram of the mirror integrated multiple camera imaging recording system.

### DETAILED DESCRIPTION OF THE INVENTION

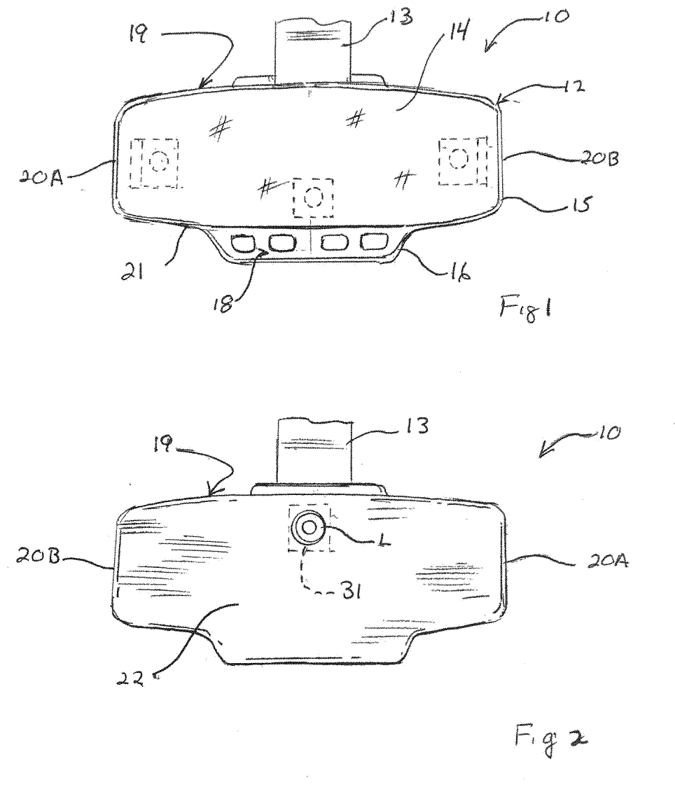

Referring to FIGS. 1, 2 and 4 of the drawings, an integrated rearview mirror surround camera imaging recording system 10 of the invention for vehicles V can be seen. A rearview mirror mounting configuration 11 has a main housing assembly 12 with an upstanding windshield support mounting arm 13 extending therefrom and a rearview mirror 14 positioned there within.

The main housing assembly 12 has a dedicated front mirror retainer mount frame 15 and integral elongated contoured control extension areas 16 for mounting multiple activation controls 18 shown generally for illustration purposes only in FIG. 1 of the drawings.

The main housing assembly 12 has a contoured top surface 19 with oppositely disposed depending end walls 20A and 20B with an interconnected bottom 21 and an apertured rear housing enclosure wall 22. The housing bottom 21 has a correspondingly recessed contoured central portion 21A which corresponds to the contoured extension 16 of the mirror retainer mount frame 15, described above.

The main housing assembly 12 therefore defines a four sided component insert access opening at 23 with corresponding perimeter mounting edge 24 for removable registration with that of said front mirror retainer mount frame 15, referred to above.

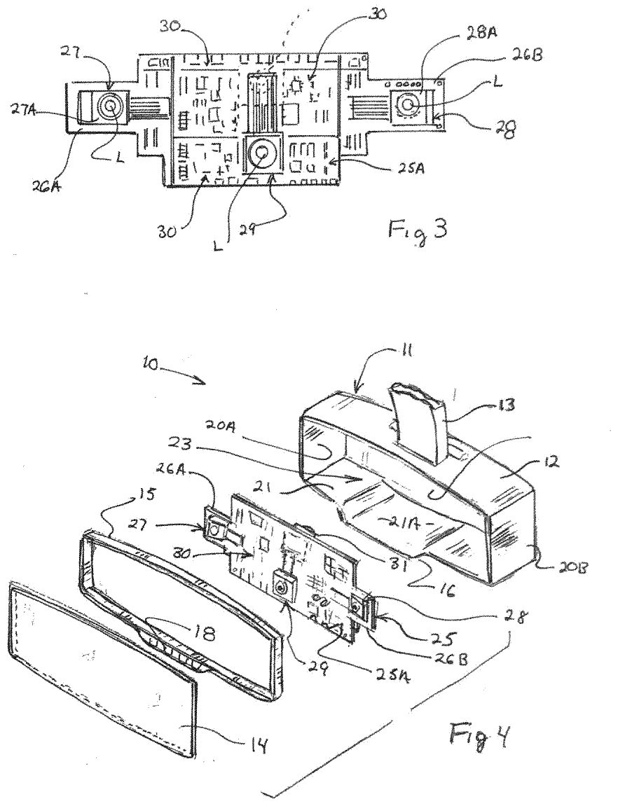

An electronic video component support and control circuit board assembly 25 is provided and is best seen in FIGS. 3 and 4 of the drawings. The control circuit board 25 has an electronic component mounting surface 25A with oppositely disposed tab extensions 26A and 26B. The mounting surface 25A has, in this example, three independent video imaging camera components 27, 28 and 29 mounted thereon with corresponding electronic support components 30 mounted thereto as will be well understood by those skilled in the art.

The electronic components 30 provide multiple processes including image processing, communications, and data image support capabilities and component power supply as will be described in greater detail hereinafter.

The camera components 27 and 28 are mounted on the respective tab extensions 26A and 26B in elongated spaced relation to one another.

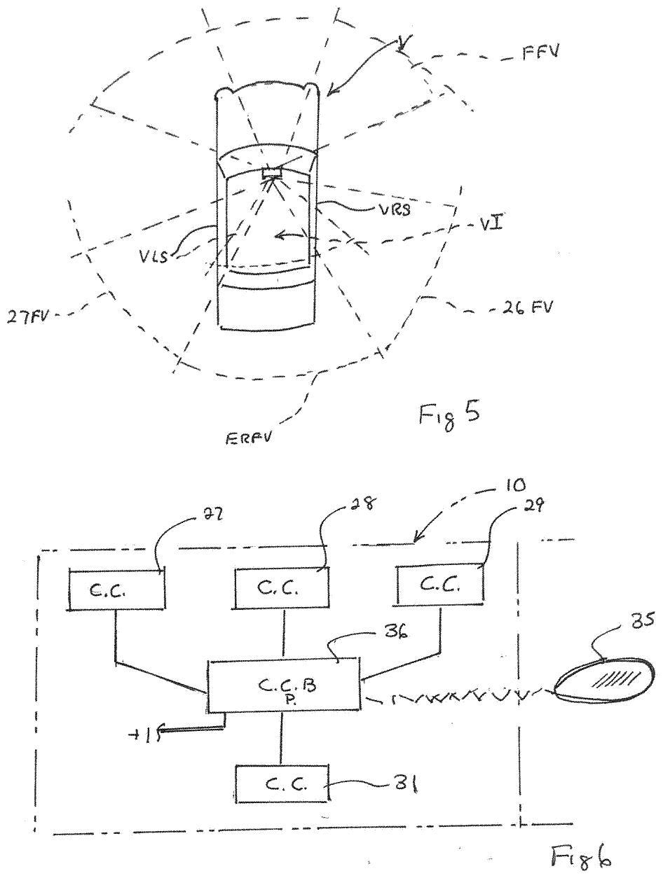

Each of the camera components 27 and 28 has an angular offset lens mounting surface 27A and 28A which, in combination, with respective lenses L thereon afford a corresponding interlinked field of view, 27FV and 28FV that corresponds to the vehicle's V respective right VRS side and left VLS side as illustrated graphically in FIG. 5 of the drawings.

The remaining front surface 25 mounted camera component 29 is mounted centrally midway between respective hereinbefore described camera components 27 and 28 as best seen in FIGS. 1 and 2 of the drawings. The “center” camera component 29 has a flat surface lens mount 29A with a wide field of view lens L adapted to provide a depth of field image of both the vehicle's interior VI as well as the exterior rear field of view ERFV which emulates the visual rearview achieved by the rearview mirror by users within the vehicle.

A vehicle front facing camera component 31 is mounted on the control circuit board's 25 opposite surface 32 in vertical offset spaced relation to the camera component 29 as shown in dotted lines in FIG. 3 of the drawings and in solid lines partially viewable in FIG. 4 of the drawings. The front facing camera component 31 defines a forward field of view FFV designated in and best seen in FIGS. 5 and 6 of the drawings.

Each of the camera components 27, 28, 29 and 31 therefore has multiple pins communication leads interlinking them with the hereinbefore described electronic support components 30 on the circuit board assembly 25 as orientationally needed.

The rearview mirror camera image and recording system 10 of the invention will provide video capture and documentation of events immediately around the outside of the vehicle V as well as the interior VI including the driver and passengers, not shown, transmitting to a cloud base data processing and receiving system 35 through a wireless communication 36 venues including wi-fi, Bluetooth, cell phone platforms and central processor.

It will be evident from the above description that the imaging capture documentation system, as described, will view and archive through the multiple camera views virtually everything occurring associated with the vehicle's position as well as the occupants of the vehicle and provide an accessible documentation record for further review, as required.

The system will provide a combination of overlapping video surveillance with remote recording for ease of future access, as noted.

It will thus be seen and a new and novel integral rearview mirror surround camera image recording system has been illustrated and described and it will be apparent to those skilled in the art that various changes and modifications may be made thereto without departing from the spirit of the invention.

We claim:

1. An integrated multi-view surveillance camera system, comprising:
an imaging recording system in a vehicle's rearview mirror,
an integrated electronic circuit board; and
a multiple camera mounting platform.
